(19) United States
(12) Patent Application Publication
(10) Pub. No.: US 2018/0363803 A1
(43) Pub. Date: Dec. 20, 2018

(54) Structure for Vane-Type Valve Assembly

(71) Applicant: Whirlpool S.A., Sao Paulo (BR)

(72) Inventor: Evandro Luiz Lange PEREIRA, Joinville (BR)

(21) Appl. No.: 16/007,125

(22) Filed: Jun. 13, 2018

(30) Foreign Application Priority Data
Jun. 19, 2017 (BR) 10 2017 013190 4

(51) Int. Cl. F16K 47/02; F16K 15/14; F16K 25/00

(52) U.S. Cl. CPC F16K 47/02; F16K 25/00; F16K 15/144

(57) ABSTRACT

An arrangement for a valve assembly in a positive displacement compressor. The arrangement has a structure for vane-type valve assembly including at least one seating plane and at least one sealing plane, wherein both are angularly out of alignment from one another, where the seating plane is defined at a first angle and the sealing plane is defined at a second angle.

### FIELD OF THE INVENTION

The present invention refers to a structure for vane-type valve assembly in a positive displacement compressor and, more particularly, a structure comprising a base for seating and/or fixing the static end of a vane-type valve. The general objective of the present invention is to provide a simplified means capable of determining the initial state of the vane-type valve.

### FUNDAMENTALS OF THE INVENTION

As known to those skilled in the art, positive displacement compressors, also known as reciprocating compressors, typically include a fluid compression system that includes a control mechanism of the suction and discharge of working fluid. In general terms, such control mechanism basically consists of at least one suction valve and at least one discharge valve, which are able to clog/unclog the holes by which the working fluid enters or exits from the compression cylinder.

Occasionally, suction valves or discharge valves may also be applied, in order to perform an analogous or equivalent function, in other components or mechanisms that make part of a positive displacement compressor. There are known, for example, technical solutions in which suction valves or discharge valves can be used in acoustic filters that make part of the positive displacement compressor.

Although there are known different types of valves that can be used in positive displacement compressors, it is of particular interest, according to the core of the present invention, to consider the vane-type valves. Briefly, a vane-type valve is that formed by a flexible metal blade. In general terms, a vane-type valve comprises a substantially static end, capable of being fixedly seated and/or fixed to a compressor structure, and a dynamic end, able to clog/unclog one or more holes through which the working fluid flows.

Vane-type valves, especially those used as suction valves or discharge valves in positive displacement compressors, are well known to those skilled in the art. Inclusively, an infinitude of models, normally variable in the geometrical aspect, of vane-type valves are pertaining to the current state of the art.

In the vast majority of applications of vane-type valves in positive displacement compressors, it is common for the initial state of said valve, relative to its working hole, to be normally closed, that is, it is common that in the absence of factors and stimulus the valve is mounted in any structure so as to keep its working hole sealed/clogged.

FIG. 1A shows, in a schematic and simplified manner, a trivial situation in which a vane-type valve B has an initial state, with respect to the hole C, normally closed. In this exemplification the vane-type valve B is fixed in a structure A, wherein its static end B1 is fixed in a plane A1 of the structure A by means of an pierced fixing element C, and its dynamic end B2 is seated on the hole C in a plane A2 of the structure A. It is observed that the planes A1 and A2 of the structure A are horizontally equivalent, that is, they are defined on a same horizontal level.

In addition, as is well known to those skilled in the art, it is known that certain applications may take advantage if a vane-type valve has its initial state normally opened. For example, it is mentioned cases in which it is desired to maintain a suction valve opened at the starting instant of the positive displacement compressor in order to decrease the starting torque of the compressor motor.

In general terms, two constructive possibilities of obtaining a vane-type valve in the initial state opened are known. Such constructive possibilities are shown, in a schematic and simplified manner, in FIGS. 1B and 1C.

The constructive possibility shown in FIG. 1B involves a traditional structure A and a pre-tensioned vane-type valve B. Said pre-tensioned vane-type valve B, normally obtained by means of a mechanical stamping process, is deformed so as to present a difference in level between the static end B1 and the dynamic end B2. Thus, although the static end B1 of the pre-tensioned vane-type valve B is fixed coplanar to the plane A1 of the structure A, its dynamic end B2 is naturally spaced apart from the hole C and the plane A2 of the structure A. It is observed that planes A1 and A2 of structure A are horizontally equivalent, that is, they are defined on a same horizontal level. That is, a vane-type valve can act with the initial state normally opened if it is made in a pre-tensioned form. However, this constructive possibility normally, as it is based on plastic deformation, tends to shorten the service life of the valve, especially at the pre-tension point B3 defined by hydraulic press knock.

Further examples of the constructive possibility shown in FIG. 1B may be verified in patent document WO 2015/113127.

The constructive possibility shown in FIG. 1C involves a traditional vane-type valve B and a modified structure A, which comprises a projection A3 between the planes A1 and A2. Therefore, it is observed that the planes A1 and A2 of the structure A are horizontally equivalent to each other, the projection A3 existing in a raised plane, however, coplanar to the planes A1 and A2. Thus, although the entire extent of the vane-type valve B is disposed in a coplanar manner relative to the structure A, its dynamic end B2 is naturally spaced apart from the hole C and the plane A2 of the structure A. That is, a vane-type valve can act with the initial state normally opened if the structure on which it is mounted (usually, but not obligatorily, a metal valve plate) contains a vertical spacer. However, this constructive possibility presents severe sealing problems.

Further examples of the constructive possibility shown in FIG. 1C can be verified in the patent document WO 2005/033510.

It is then based on the scenario presently reported that the present invention arises.

### OBJECTIVES OF THE INVENTION

Thus, it is the primary objective of the present invention to provide a structure for vane-type valve assembly in positive displacement compressor capable of maintaining a vane-type valve in initial state normally opened without the need to perform deformations in the valve, and in a simplified form with regard to its manufacturing process.

It is further an objective of the present invention to disclose an inventive core whose possibility of application extends to any and every structure for vane-type valve assembly in positive displacement compressor.

More particularly, it is an objective of the present invention to disclose an inventive core whose possibility of application achieves polymeric structures for vane-type valve assembly in a positive displacement compressor, such as the internal polymeric walls of an acoustic filter used in positive displacement compressors.

### SUMMARY OF THE INVENTION

The objectives summarized above are fully achieved by means of the structure for vane-type valve assembly, which comprises at least one seating plane (for the static end of a vane-type valve) and at least one sealing plane (for the dynamic end of a vane-type valve), wherein the seating plane and the sealing plane are angularly out of alignment from each other.

That is, in accordance with the present invention, the seating plane of the structure for vane-type valve assembly is defined at a first angle α and the sealing plane of the structure for vane-type valve assembly is defined at a second angle β.

### BRIEF DESCRIPTION OF THE DRAWINGS

The present invention will now be described in detail on the basis of the illustrative figures listed below, which:

FIGS. 1A, 1B and 1C show constructive embodiments of solutions directed to the technological field addressed herein, in accordance with the current state of the art;

FIG. 2 shows, in accordance with the preferred embodiment of the present invention, the structure for vane-type valve assembly;

FIG. 3 shows, in an exploded manner, the structure for vane-type valve assembly with a vane-type valve;

FIG. 4 shows, in assembled form, the structure for vane-type valve assembly with a vane-type valve in opened natural condition;

FIG. 5 shows, in assembled form, the structure for vane-type valve assembly with a vane-type valve in closed functional natural condition;

FIG. 6 shows a first optional embodiment of the structure for vane-type valve assembly;

FIG. 7 shows a second optional embodiment of the structure for vane-type valve assembly; and

FIG. 8 shows a third optional embodiment of the structure for vane-type valve assembly.

### DETAILED DESCRIPTION OF THE INVENTION

According to the principal objectives of the present invention, it is disclosed a structure for vane-type valve assembly able to make possible maintenance of the vane-type valve in an initial state normally opened without the need for said vane-type valve to be made in a pre-tensioned form.

In this regard, it should be highlighted that said vane-type valve 2 is a totally traditional valve, that is, which comprises a static end 21 (especially dedicated to fixing the valve in a fixed reference) and a dynamic end 22 (especially dedicated to movement as a function of external stimulus), said ends 21 and 22 being distally opposed.

According to the general objective of the present invention, said vane-type valve 2, even being traditional, is maintained in an initial state normally opened due to the structure 1, which basically comprises a seating plane 11 (especially adapted for receiving the static end 21 of the vane-type valve 2) and the sealing plane 12 (which, comprising the working hole 14, is specially adapted for cooperation with the dynamic end 22 of the vane-type valve 2), wherein the seating plane 11 and the sealing plane 12 are angularly out of alignment from each other.

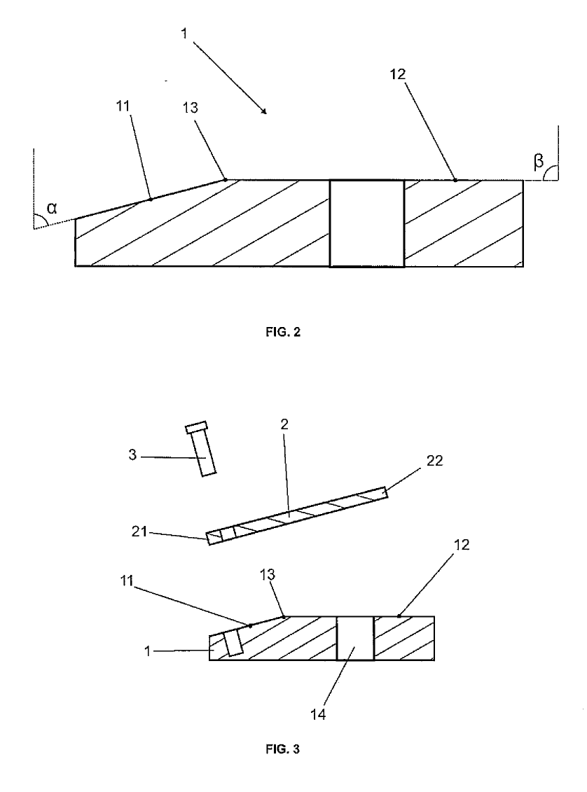

More particularly, as shown in FIG. 2, the seating plane 11 is defined at a first angle α, and the sealing plane 12 is defined at a second angle β, wherein the angular difference between said planes is greater than 90° and less than 180°.

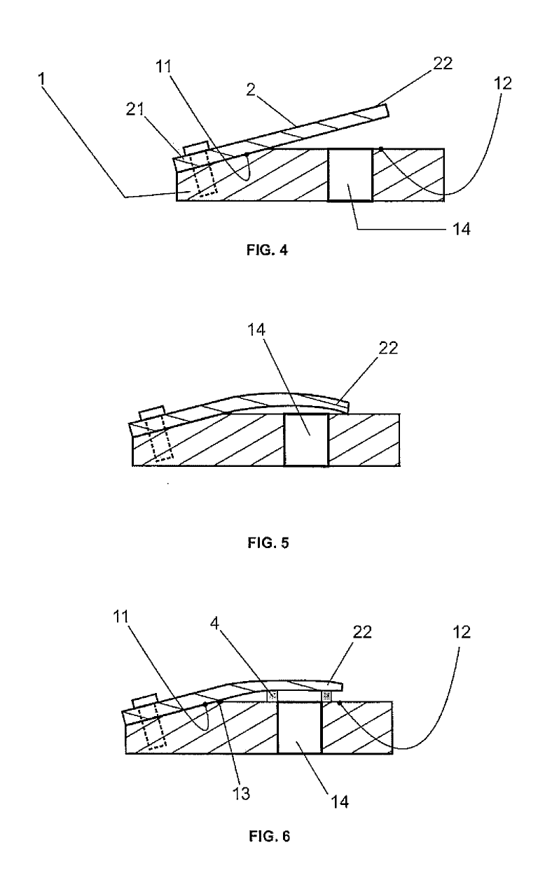

Considering that the static end 21 of the vane-type valve 2 is fixed to the seating plane 11 of the structure 1 (by means of a conventional fixing component 3, as shown in FIG. 3), the spacing between the dynamic end 22 of the vane-type valve 2 and the hole 14 of the structure 1 is defined directly by the angulation of the seating plane 11, as shown in FIG. 4.

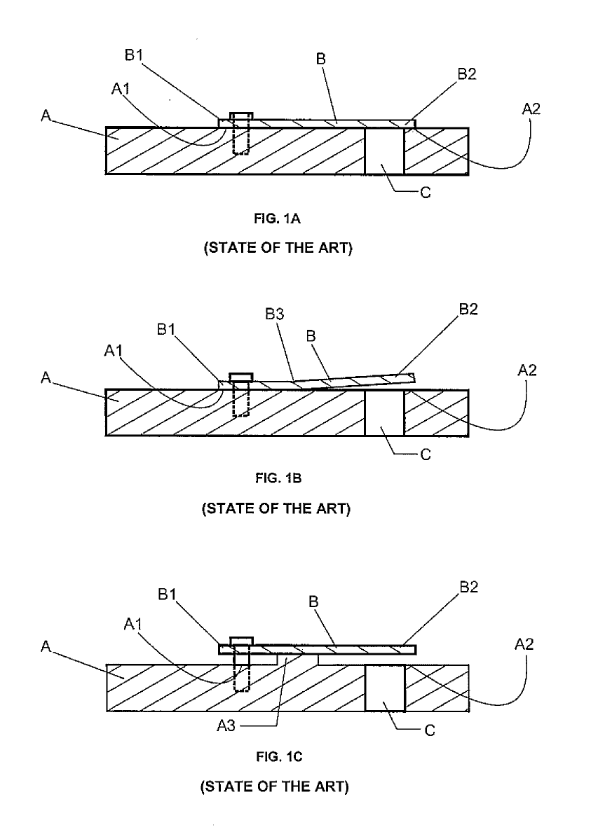

Like this, the vane-type valve 2 is maintained in an initial state normally opened without the need for it to undergo physical-mechanical blemishes (as exemplified in FIG. 1B) and without the need for the structure itself to be made with a vertical spacer (as exemplified in FIG. 1C).

As shown in FIG. 5, the dynamic end 22 of the vane-type valve 2, when closed, has its deformation point defined near the transition point 13 of the structure 1. Said transition point 13 of the structure 1 comprises the bordering point between the seating plane 11 and the sealing plane 12 of the structure 1. In this regard, it is verified that the transition point 13 of the structure 1 (and, consequently, the vertical extensions of the planes 11 and 12) can be defined according to the general needs of the project such as the flexibility of the vane-type valve 2.

Preferably, as shown in FIGS. 2, 3 and 4, it is verified that the transition point 13 and the sealing plane 12 are coplanar. However, this condition is not an obligation, after all, as shown in FIG. 8, the sealing plane 12 may be inclined with respect to the transition point 13, that is, the transition point 13 and the sealing plane 12 are defined in different horizontal planes.

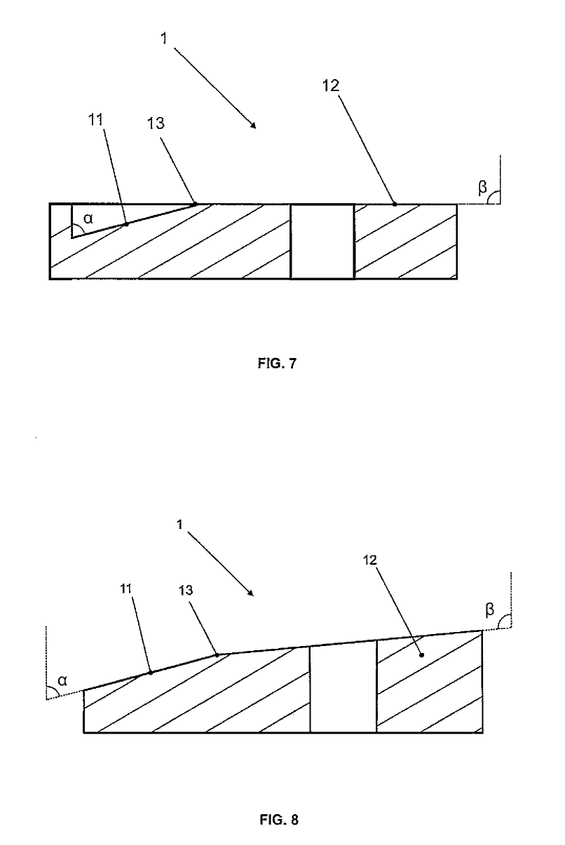

From a factory point of view, the structure 1 can be manufactured in simplified form, after all, the seating plane 11 can be obtained, in a controlled manner, by mechanical stamping, machining or thermoforming process. As shown in FIG. 7, the seating plane 11 may comprise a cavity with inclined bottom formed from the sealing plane 12.

As shown in FIG. 6, the structure 1 can receive on its sealing plane 12, preferably around the hole 14, a coplanar spacer element 4, which is capable of optimizing the seal between the dynamic end 22 of the vane-type valve 2 and the hole 14 of the structure 1.

According to the present invention, the structure 1—as explained above—may comprise a valve plate (see attached illustrations) or may comprise a wall of an acoustic filter (embodiment not particularly shown, but of easy intuition).

It is important to emphasize that the above description has the sole purpose of describing, in an exemplary manner, the particular embodiment of the utility model in question. Therefore, it is clear that modifications, variations and constructive combinations of the elements performing the same function substantially in the same manner to achieve the same results, remain within the scope of protection defined by the appended claims.

1. Structure for vane-type valve assembly, comprising at least one seating plane and at least one sealing plane, being especially characterized by the fact that the seating plane and the sealing plane are angularly out of alignment from each other.

2. Structure, according to claim 1, characterized by the fact that:
the seating plane is defined at a first angle (α); and
the sealing plane is defined at a second angle (β).

3. Structure, according to claim 1, characterized by the fact that the seating plane comprises a cavity with inclined bottom formed from the sealing plane.

4. Structure, according to claim 1, characterized by the fact that the transition point and the sealing plane are coplanar.

5. Structure, according to claim 1, characterized by the fact that the structure further comprises at least one coplanar spacer element arranged on the sealing plane.

6. Structure, according to claim 1, characterized by the fact that the structure comprises a valve plate.

7. Structure, according to claim 1, characterized by the fact that the structure comprises a wall of an acoustic filter.
